(19) United States
(12) Patent Application Publication
(10) Pub. No.: US 2014/0013843 A1
(43) Pub. Date: Jan. 16, 2014

(54) Inertial Sensor Mounting System

(71) Applicants: Roy V. Buck, Oak Ridge, NC (US); Darrell P. Adams, Oak Ridge, NC (US); Joseph S. Bergeron, Greensboro, NC (US)

(72) Inventors: Roy V. Buck, Oak Ridge, NC (US); Darrell P. Adams, Oak Ridge, NC (US); Joseph S. Bergeron, Greensboro, NC (US)

(73) Assignee: ANALOG DEVICES, INC., Norwood, MA (US)

(21) Appl. No.: 13/545,232

(22) Filed: Jul. 10, 2012

(51) Int. Cl. G01P 1/02

(52) U.S. Cl. 73/493

(57) ABSTRACT

Embodiments of the present invention include various mounting systems (referred to herein as “carriers”) on which multiple matched inertial sensors (e.g., gyroscopes or accelerometers) can be mounted in a fixed, optimized arrangement that allows for multiple-axis sensing, while maintaining the position of the inertial sensors over the life of the product.

### FIELD OF THE INVENTION

The present invention relates generally to mounting and orientation of multiple inertial sensors.

### BACKGROUND OF THE INVENTION

Many applications for inertial sensors require high-fidelity measurement in three orthogonal axes in order to properly assess motion in three dimensional space. Numerous examples of three-axis MEMS inertial sensors for gyroscopic and/or acceleration sensing exist, including, for example, ADiS1636X series, ADiS1640X series, ADiS16375, ADiS16488, ADiS16334, ADiS16300, and ADiS16448 inertial sensors sold by Analog Device, Inc. of Norwood, Mass.

In many cases, the highest performance is attained in one or two axes, with lower performance in the third orthogonal sensing axis. This limitation typically is due to the unique processing of conventional MEMS devices and the planar nature of the machining processes. In order to eliminate sensitivity to orientation and achieve maximum performance from the sensors, mechanical reorientation of the sensor and the sensor package to alternate sensing directions is common. The reorientation is often wrought with other limitations (e.g., new and orientation-defined mechanical resonances, thermal mismatches, and manufacturing expense). To maximize performance, a MEMS sensor design can be optimized for sensing in a particular plane; the burden is then on offering an assembly approach that is both economical (e.g., in terms of size, cost, etc.) and preserves the sensor performance.

MEMS sensors typically are mounted either parallel with the axis being measured or perpendicular to the axis depending on, for example, whether linear acceleration or angular acceleration and velocity are being measured. The latter generally requires a package that is designed to be mounted perpendicular to the axis being measured for gyroscope applications. Sometimes, the sensor in a surface mount package is attached to a carrier printed circuit board (PCB), and the carrier PCB in turn is mounted perpendicular to the planar mother board PCB in order to provide the vertical mount. These vertical mounted structures are sensitive to mechanical shock and vibration, which can cause performance degradation or failure. The process for mounting to the mother board PCB is expensive. In some cases, support brackets are needed to strengthen the structural integrity of the assembly and to dampen vibration sensitivities. Overall, optimal positioning of the sensors in relation to one another can be difficult to accomplish on a repeatable basis, and the structural stability over operating temperatures and life could vary.

Another issue with MEMS inertial sensor is sensitivity to stresses, e.g., between the sensor package and the sensor elements. For example, sensor elements are often made of silicon, while the sensor package may be ceramic made from approximately 90% alumina. This alumina package typically has a TCE (Temperature Coefficient of Expansion) of 6 to 8 ppm, whereas the silicon sensor elements typically have a TCE of 2.5 to 4 ppm. This can cause stress to be imparted to the sensor elements, which can degrade their performance.

Various packaging approaches that utilize non-planar mounting of inertial sensors are known, including approaches that utilize three inertial sensors arranged in a triad configuration (i.e., where the axes of orientation of the inertial sensors form three orthogonal axes). Some examples can be found in U.S. Pat. Nos. 4,179,818, 5,042,156, 6,718,280, 7,370,530, 7,814,791, 7,912,664; U.S. Published Patent Application Numbers 2009/0292396 and 2010/0063763; and in the following publications: Lappas et al., Practical Results on the Development of a Control Moment Gyro based Attitude Control System for Agile Small Satellites; Lappas et al., Experimental Testing of a CMG Cluster for Agile Microsatellites, IEEE 12^{th} Mediterranean Conference on Control and Automation MED '03, 2003; Gilmore, Jerold P., A Non-Orthogonal Gyro Configuration, Massachusetts Institute of Technology, January 1967; Hanson, R., Using Multiple MEMS IMUs to Form a Distributed Inertial Measurement Unit, Air Force Institute of Technology, March 2005; Yavuzoglu, E., STEERING LAWS FOR CONTROL MOMENT GYROSCOPE SYSTEMS USED IN SPACECRAFTS ATTITUDE CONTROL, The Middle East Technical University, November 2003; Paradiso, J., Global Steering of Single Gimballed Control Moment Gyroscopes Using a Directed Search, AIAA Guidance and Control Conference, New Orleans, La. 1991; Yoganandan, N. et al., Lightweight Low-Profile Nine-Accelerometer Package to Obtain Head Angular Accelerations in Short-Duration Impacts, Journal of Biomechanics 39 (2006) 1347-1354. Each of these references is incorporated herein by reference in its entirety.

### SUMMARY OF EXEMPLARY EMBODIMENTS

In on exemplary embodiment there is provided apparatus for mounting a plurality of inertial sensor assemblies, each inertial sensor assembly including an inertial sensor, the inertial sensors configured for sensing movement relative to three orthogonal axes, the carrier comprising a carrier having a plurality of inertial sensor mounting surfaces oriented in a non-planar arrangement with none of the mounting surfaces aligned with any of the three orthogonal axes, the carrier formed of a rigid material having a coefficient of thermal expansion substantially matched to a coefficient of thermal expansion of the inertial sensor assemblies.

In various alternative embodiments, the carrier may include three mounting surfaces, and these mounting surfaces may be offset at an angle of substantially 54.7 degrees to a plane of a base of the carrier and offset from one another by substantially 120 degrees around a vertical axis. Each mounting surface may include at least one alignment feature for positioning an inertial sensor assembly, which may include a packaged inertial sensor, an unpackaged inertial sensor, or an interposer printed circuit board having an inertial sensor.

The carrier may include a base. The carrier may include electrical connections from the mounting surfaces to the base. The base may include a ball grid array associated with the electrical connections. The base additionally or alternatively may include at least one base alignment feature for positioning the carrier on a product. The carrier may include a plurality of leaf contacts. The carrier may be formed from mullite, silicon nitride, silicon carbide, or low-thermal-expansion borosilicate glass.

Certain embodiments include the carrier with the inertial sensor assemblies mounted on the carrier. The inertial sensor assemblies may be packaged inertial sensors, unpackaged inertial sensors, or interposer printed circuit boards with each printed circuit board having an inertial sensor.

Additional embodiments may be disclosed and claimed.

### BRIEF DESCRIPTION OF THE DRAWINGS

The foregoing features of embodiments will be more readily understood by reference to the following detailed description, taken with reference to the accompanying drawings, in which:

FIG. 1 is a schematic diagram showing various views of one specific exemplary embodiment of a carrier;

FIGS. 2 and 3 are alternative side perspective views of the carrier of FIG. 1;

FIG. 4 is a schematic diagram showing an alternative carrier having a single elongated base alignment feature and an alternative nest-type alignment structure;

FIG. 5 is a schematic diagram showing an alternative version of the carrier of FIG. 4;

FIGS. 6 and 7 are schematic diagrams showing the carrier of FIG. 5 mounted to a PCB in accordance with one exemplary embodiment; and

FIGS. 8 and 9 are schematic diagrams showing an arrangement of electrical connections from the mounting surfaces to the base, in accordance with one exemplary embodiment.

It should be noted that the foregoing figures and the elements depicted therein are not necessarily drawn to consistent scale or to any scale. Unless the context otherwise suggests, like elements are indicated by like numerals.

### DETAILED DESCRIPTION OF SPECIFIC EMBODIMENTS

Embodiments of the present invention include various mounting systems (referred to herein as “carriers”) on which multiple matched inertial sensors (e.g., gyroscopes or accelerometers) can be mounted in a fixed, optimized arrangement that allows for multiple-axis sensing, while maintaining the position of the inertial sensors over the life of the product. The carrier includes multiple mounting surfaces that place the inertial sensors in substantially matched orientations (e.g., at the same angle relative to a predetermined vertical axis of the carrier and at the same angle relative to a base of the carrier), which, among other things, tends to reduce mismatched orientation-related effects on the inertial sensors that otherwise might exist if the inertial sensors are oriented at different angles. The carrier can be mounted to a product (e.g., a PCB, vehicle bulkhead, etc.) such that the inertial sensors are positioned in a fixed arrangement relative to one another and relative to the product. Thus, the carrier allows for optimized sensor placement that can be obtained reliably and economically, thereby improving the performance of the sensors compared to traditional mounting approaches that require multiple package approaches (e.g., vertical and horizontal mounting), unique manufacturing flows (e.g., flex routing), or different sensor processing technologies (e.g., in-plane versus out-of-plane sensing).

In various alternative embodiments, the inertial sensors may be packaged devices or unpackaged devices and may be mounted directly or indirectly (e.g., using an interposer PCB) to the mounting surfaces of the carrier. The mounting surfaces may include one or more alignment structures (e.g., tabs, nest, etc.) to ensure that the inertial sensors are placed in a precise position and orientation. Additionally or alternatively, the mounting surfaces may include one or more electrical connectors for electrically connecting the inertial sensor or inertial sensor assembly (e.g., an interposer PCB containing an inertial sensor) to the mounting surface. In order to reduce stresses imparted by the carrier on the inertial sensors and maintain the inertial sensors in fixed alignment with one another, the carrier is preferably formed of a rigid material having a similar coefficient of thermal expansion (CTE) to that of the device that is mounted to the carrier (e.g., the sensor package, sensor substrate, or interposer PCB).

In certain exemplary embodiments, the carrier may be fabricated from a rigid material such as mullite, silicon nitride, silicon carbide, or low-thermal-expansion borosilicate glass (e.g., PYREX(™)) having a CTE that closely matches the CTE of silicon, although other materials may be used that closely match the CTE of silicon or other device material that is mounted to the carrier. The carrier material preferably is not sensitive to mechanical deformation or changing properties as a result of moisture absorption, as deformation or changing properties may change the relative alignment of the inertial sensor and/or the overall performance of the carrier/sensor assembly. Generally speaking, the carrier is mechanically stable, capable of surviving mechanical shocks and multiple thermal cycles, and capable of providing strong mechanical bonds, e.g., when adhesives are used to attach PCBs or silicon die to the mounting surfaces and/or to attach the carrier to the product.

In some embodiments, the carrier includes electrical connections (e.g., conductive traces, through-hole vias, etc.) from the mounting surfaces (to which the inertial sensors are electrically bonded) to the base of the carrier, such as for surface mounting or other electrical connection of the carrier base to the product. For example, the mounting surfaces may be metallized with conductor traces to which a MEMS die can be electrically connected, e.g., through wirebonding or other electrical connection. The electrical connections on the base may include solder balls (e.g., a ball grid array), electrical bond pads, a multiple-lead connector, or other electrical connections to facilitate electrical connection of the carrier to the product. Alternatively, the inertial sensors may be mounted to the carrier and wire-bonded to the product.

In some embodiments, the base includes one or more alignment features to facilitate alignment and orientation of the carrier (and hence also the inertial sensors) when the carrier is attached to the product. Alternatively, alignment and orientation of the carrier may involve just the outline of the carrier base, any electrical connections on the base, and/or other alignment features (e.g., tabs).

In some embodiments, a cover and/or coating may be used to protect the inertial sensors, electrical connections (e.g., wirebonds), and/or mechanical interconnections.

In one specific exemplary embodiment, the carrier includes a base and three mounting surfaces on which three inertial sensors can be respectively mounted in a triad configuration that allows for measurement of motion about three orthogonal axes. The base and three mounting surfaces correspond to portions of the base and three sides of a conceptual tetrahedral pyramid in which the sides are congruent with one another but not with the base (which itself is an equilateral triangle), such that the mounting surfaces are offset at precise angles to the plane of the base (e.g., around 54.7 degrees from the plane of the base) and are offset from one another around the vertical axis (e.g., at substantially 120 degrees).

Generally speaking, each inertial sensor will take up only a portion of a side of the conceptual tetrahedral pyramid (e.g., the intersection of the substantially rectangular inertial sensor with the triangular side of the conceptual tetrahedral pyramid), and, therefore, each mounting surface typically is only a portion of the side the conceptual tetrahedral pyramid, e.g., a substantially rectangular portion encompassing the intersection of the substantially rectangular inertial sensor with the triangular side of the conceptual tetrahedral pyramid. Thus, while the carrier may be configured substantially as a conceptual tetrahedral pyramid, preferred embodiments of the carrier based on the conceptual tetrahedral pyramid are cropped at each vertex about the mounting surfaces, resulting in a substantially hexagonal base and a substantially triangular top surface. Among other things, such an arrangement reduces the footprint and height of the carrier, and also reduces the amount of material used for the carrier and hence may reduce the weight and/or cost of the carrier. Additional material may be removed from the carrier, e.g., to gain further weight and/or cost savings, or to facilitate electrical connectivity to the inertial sensors.

As is known in the art, inertial sensors configured in a triad arrangement of the type discussed above can be used to sense angular velocities for each of the three orthogonal X, Y, and Z axes even though the inertial sensors are not oriented specifically for those individual axes. The rigid carrier maintains the inertial sensors in their fixed positions, which tends to reduce shock and vibration sensitivities, cross-axis sensitivities, and signal drifts that can be caused by sensor positional movement and vibration over time.

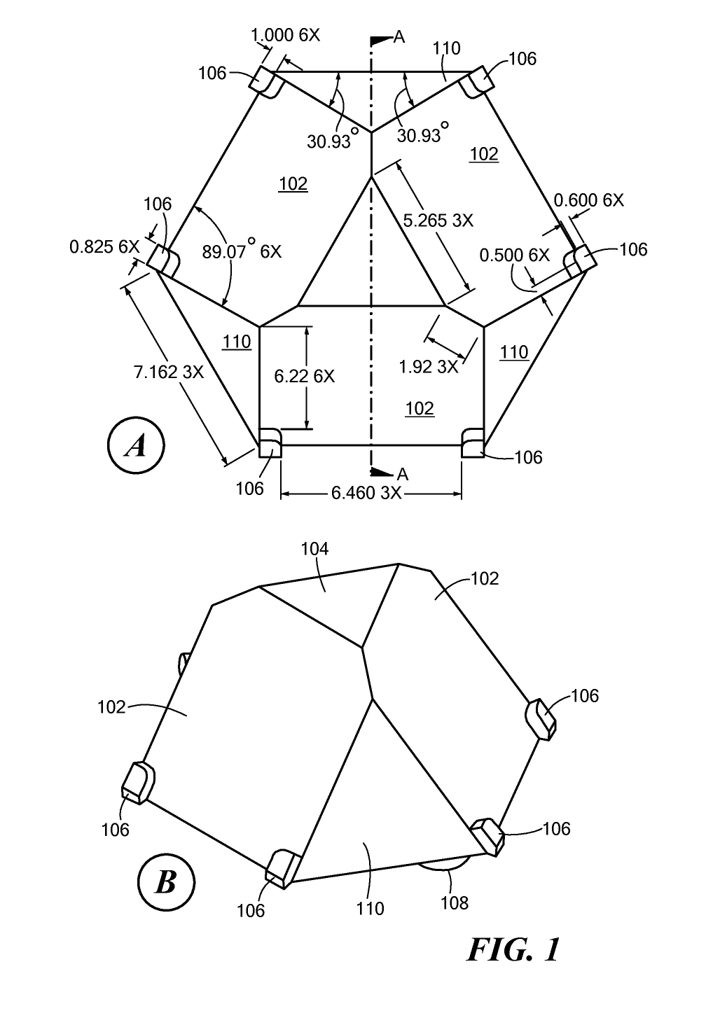

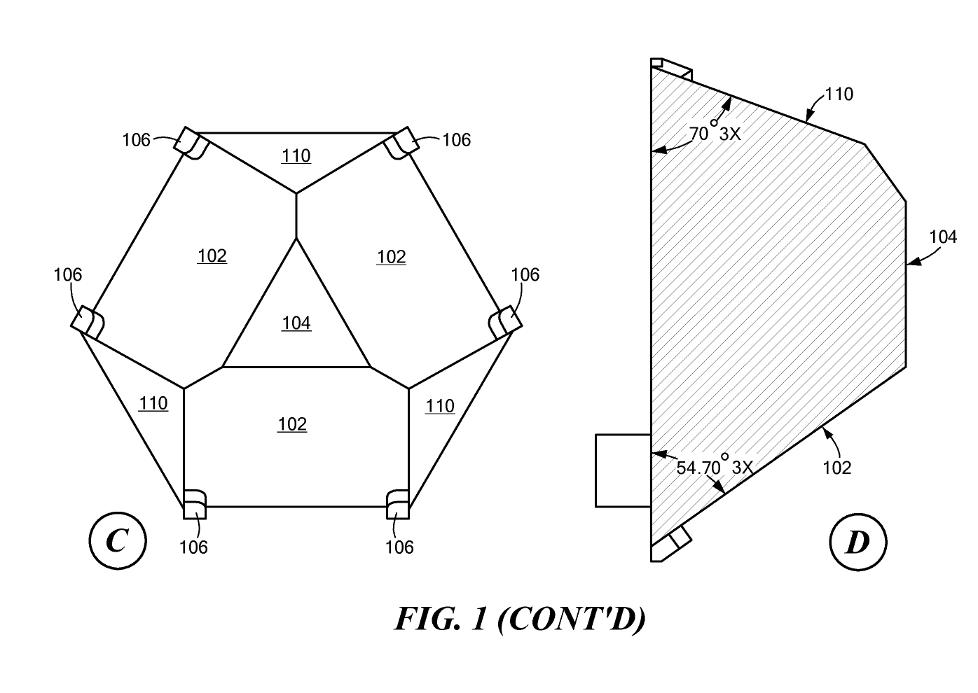

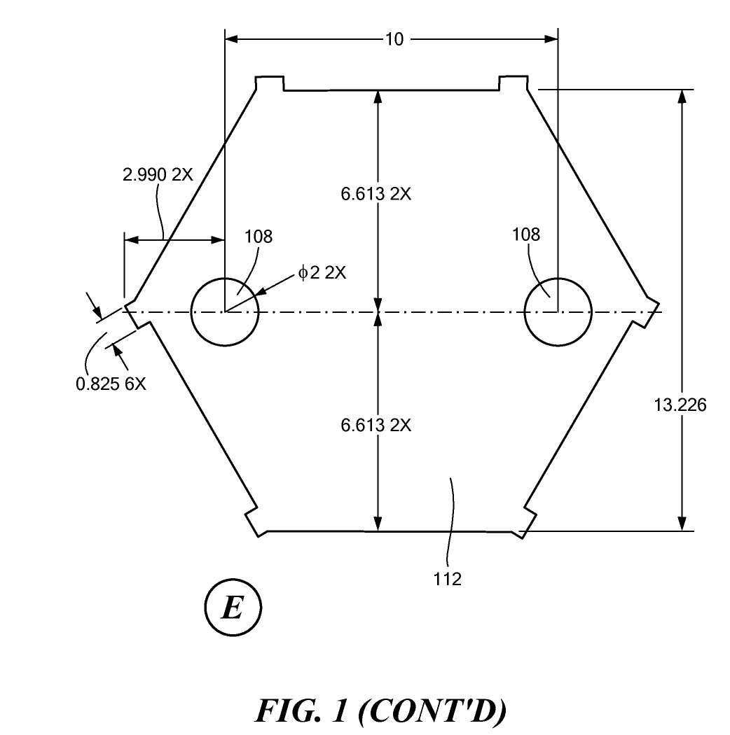

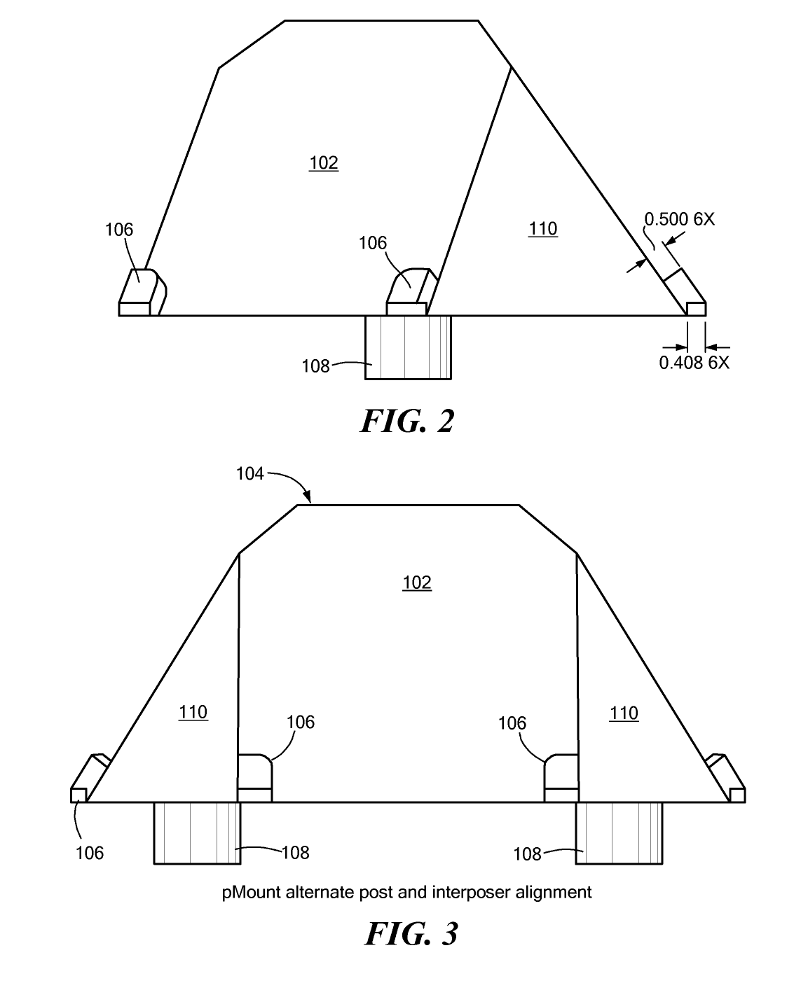

FIG. 1 is a schematic diagram showing various views of one specific exemplary embodiment of a carrier. In this figure, view C is a top perspective view of the carrier, showing the three mounting surfaces 102, the three cropped surfaces 110 between the mounting surfaces 102, the cropped top surface 104, and alignment structures 106 (in this example, two tabs on each mounting surface). View A is a top exploded view showing the elements in view C. View B is a perspective view showing the elements of view C plus a portion of a base alignment feature 108. View D is a cross-sectional view through section A-A. View E is a bottom view showing the bottom 112 with two base alignment features 108. FIGS. 2 and 3 are alternative side perspective views of the carrier of FIG. 1.

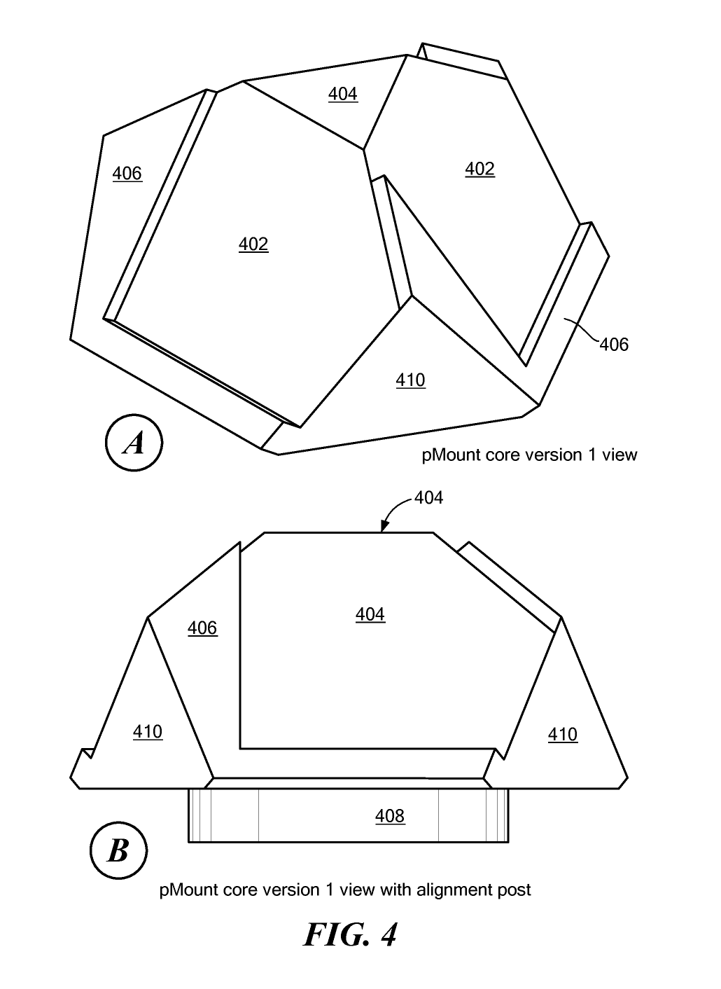

FIG. 4 is a schematic diagram showing an alternative carrier having a single elongated base alignment feature and an alternative nest-type alignment structure 406. View A is a perspective view of the carrier showing mounting surfaces 402 with alignment structures 406, the cropped top 404, and the cropped surfaces 410 between the mounting surfaces. View B is a side perspective view showing the elongated base alignment feature 408 and other elements.

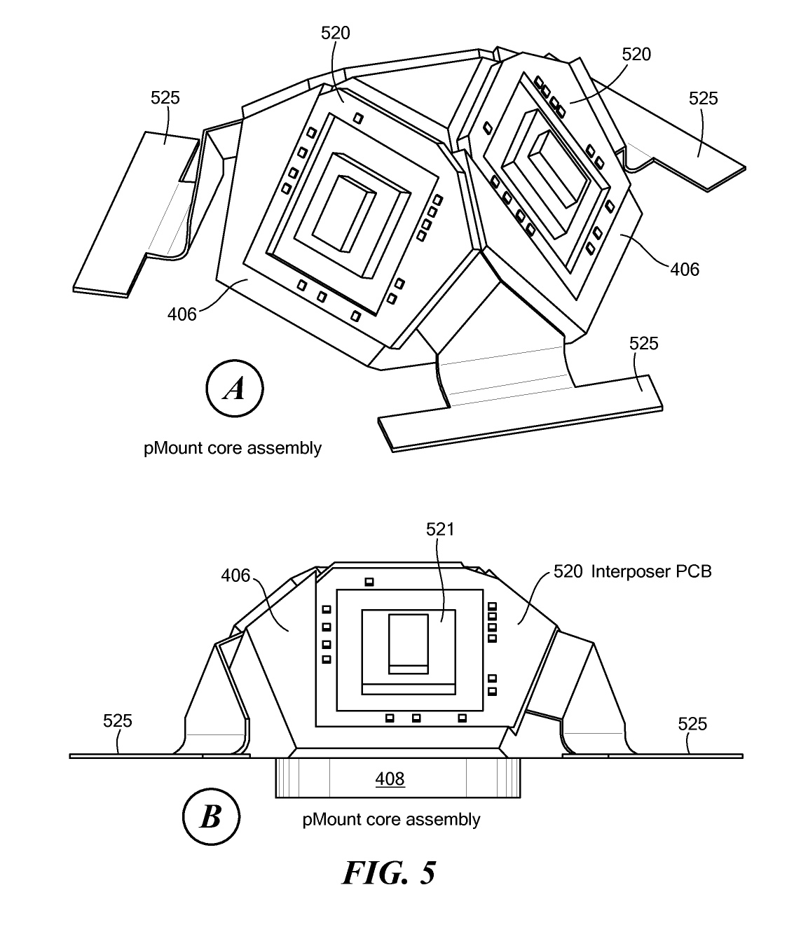

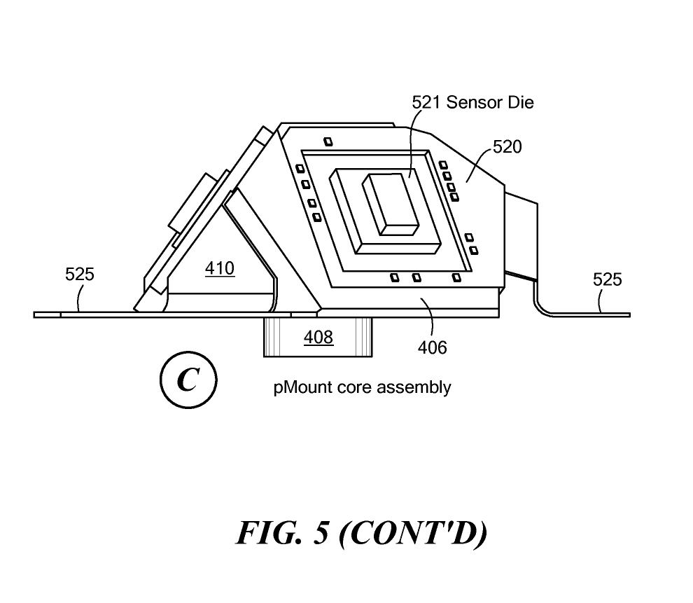

FIG. 5 is a schematic diagram showing an alternative version of the carrier of FIG. 4, with inertial sensor assemblies (including an inertial sensor 521 mounted on an interposer board 520) mounted to the carrier mounting surfaces and aligned using the alignment structures 406, and also with leaf contacts 525 for making electrical connections from the inertial sensors on the carrier to the product (not shown). View A is a perspective view. Views B and C are alternative side perspective views.

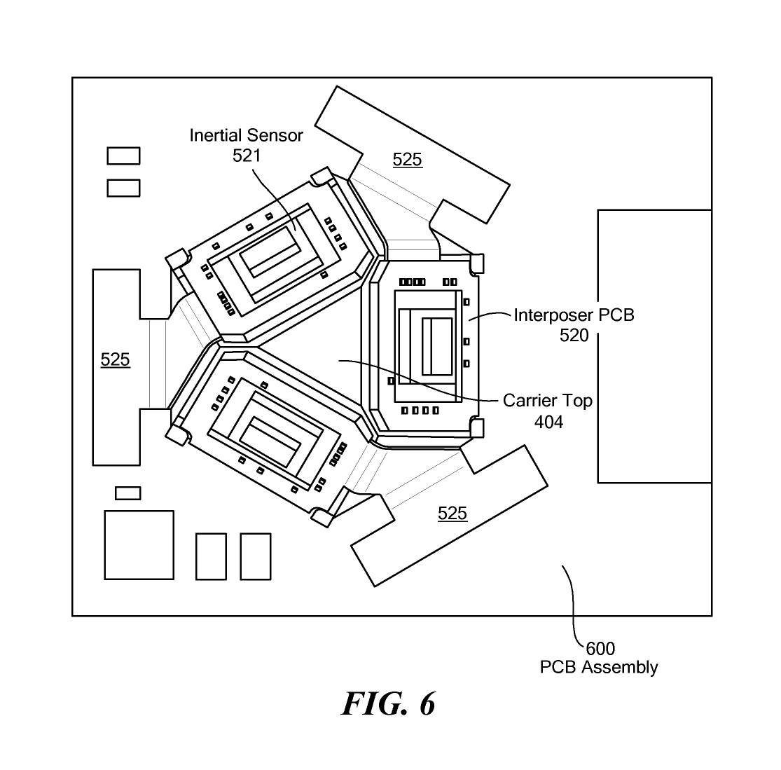

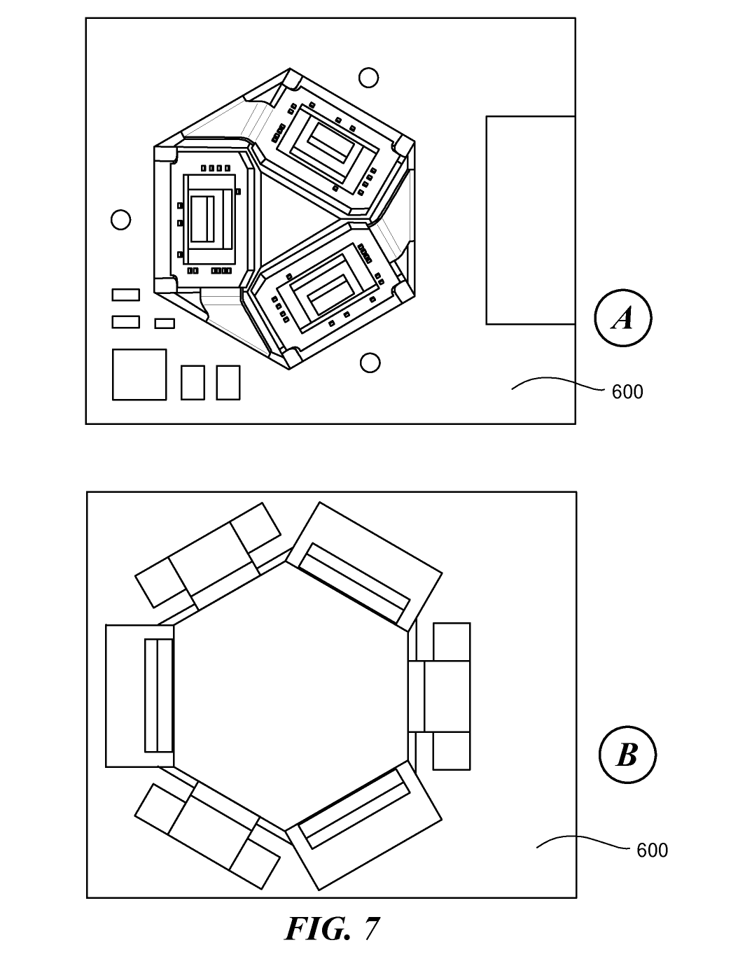

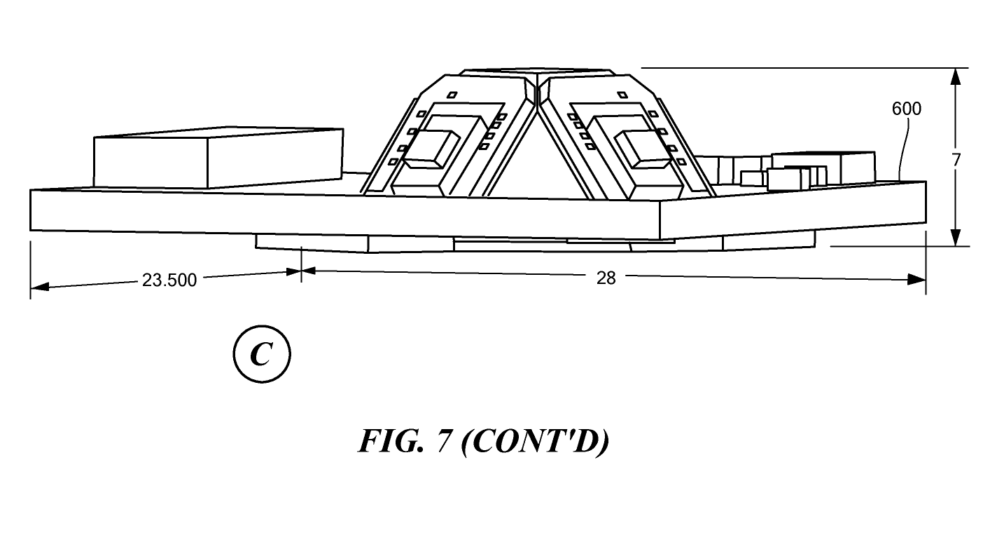

FIGS. 6 and 7 are schematic diagrams showing the carrier of FIG. 5 mounted to a PCB 600 in accordance with one exemplary embodiment. In this exemplary embodiment, the leaf contacts 525 attach to the underside of the PCB 600, as shown in View C of FIG. 7. View B of FIG. 7 shows the PCB 600 without the carrier installed. View A of FIG. 7 shows the PCB 600 with the carrier installed. FIG. 6 shows the positioning of the leaf contacts 525 when the carrier is installed.

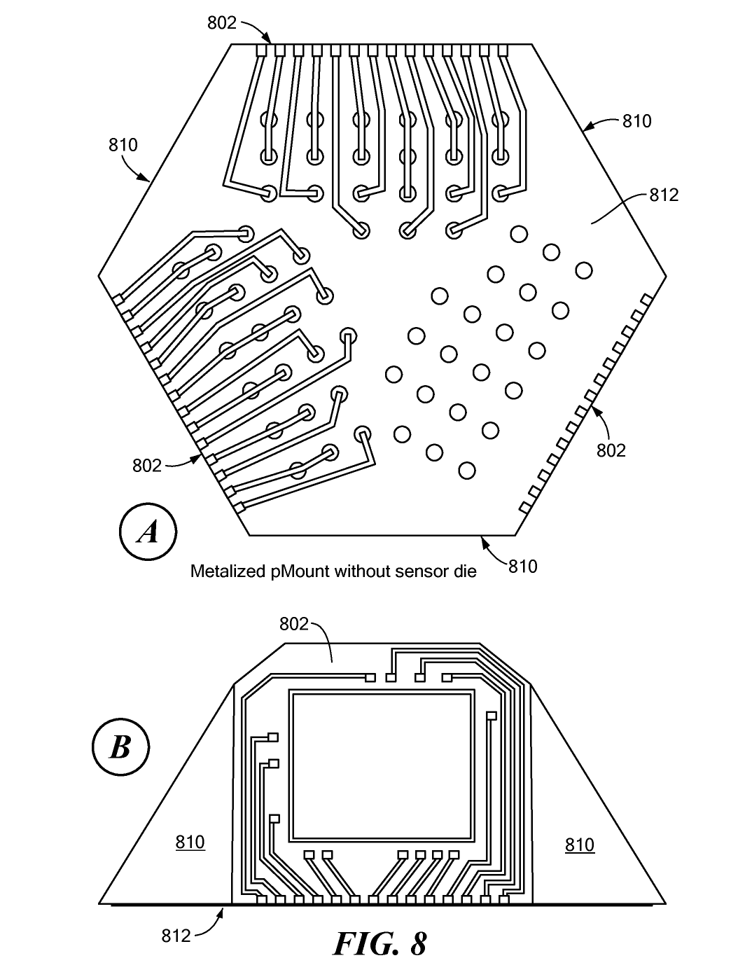

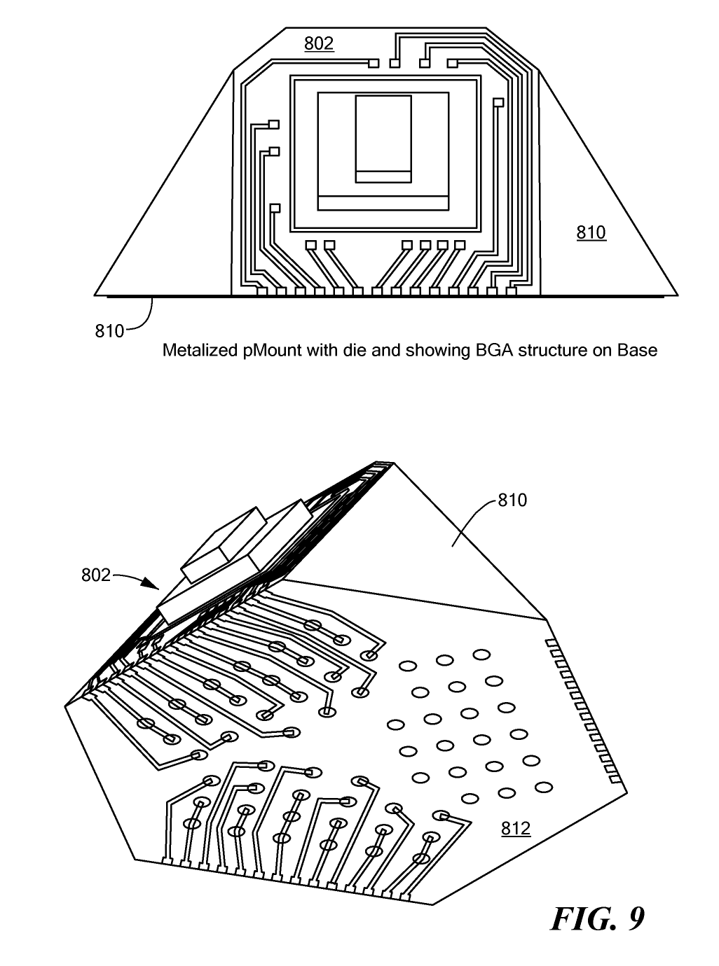

As discussed above, the carrier may be provided with electrical connections from the mounting surfaces to the base. FIGS. 8 and 9 are schematic diagrams showing an arrangement of electrical connections from the mounting surfaces to the base, in accordance with one exemplary embodiment. View B is a side view showing electrical connections from the mounting surface 802 to the bottom 812. View A is a bottom view showing the electrical connections from the mounting surfaces 802 extended along the base 812 to respective connections of a ball grid array. For convenience, some of the electrical connections are omitted in order to highlight the portion of the ball grid array. Cropped surfaces 810 are shown for convenience.

The present invention may be embodied in other specific forms without departing from the true scope of the invention, and numerous variations and modifications will be apparent to those skilled in the art based on the teachings herein. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. Apparatus for mounting a plurality of inertial sensor assemblies, each inertial sensor assembly including an inertial sensor, the inertial sensors configured for sensing movement relative to three orthogonal axes, the carrier comprising:
a carrier having a plurality of inertial sensor mounting surfaces oriented in a non-planar arrangement with none of the mounting surfaces aligned with any of the three orthogonal axes, the carrier formed of a rigid material having a coefficient of thermal expansion substantially matched to a coefficient of thermal expansion of the inertial sensor assemblies.

2. Apparatus according to claim 1, wherein the carrier includes three mounting surfaces.

3. Apparatus according to claim 2, wherein the mounting surfaces are offset at an angle of substantially 54.7 degrees to a plane of a base of the carrier and offset from one another by substantially 120 degrees around a vertical axis.

4. Apparatus according to claim 1, wherein each mounting surface includes at least one alignment feature for positioning an inertial sensor assembly.

5. Apparatus according to claim 1, wherein each mounting surface is configured to mount a packaged inertial sensor.

6. Apparatus according to claim 1, wherein each mounting surface is configured to mount an unpackaged inertial sensor.

7. Apparatus according to claim 1, wherein each mounting surface is configured to mount an interposer printed circuit board having an inertial sensor.

8. Apparatus according to claim 1, wherein the carrier includes a base, and wherein the carrier includes electrical connections from the mounting surfaces to the base.

9. Apparatus according to claim 8, wherein the base includes a ball grid array associated with the electrical connections.

10. Apparatus according to claim 1, wherein the carrier includes a base, and wherein the base includes at least one base alignment feature for positioning the carrier on a product.

11. Apparatus according to claim 1, wherein the carrier includes a plurality of leaf contacts.

12. Apparatus according to claim 1, wherein the carrier is formed from one of:
mullite, silicon nitride, silicon carbide, or low-thermal-expansion borosilicate glass.

13. Apparatus according to claim 1, further comprising the inertial sensor assemblies mounted on the carrier.

14. Apparatus according to claim 13, wherein the inertial sensor assemblies are packaged inertial sensors.

15. Apparatus according to claim 13, wherein the inertial sensor assemblies are unpackaged inertial sensors.

16. Apparatus according to claim 13, wherein the inertial sensor assemblies are interposer printed circuit boards, each printed circuit board having an inertial sensor.
